(19) United States
(12) Patent Application Publication
(10) Pub. No.: US 2010/0057639 A1
(43) Pub. Date: Mar. 4, 2010

(54) SYSTEM AND METHOD FOR UTILIZING TIME MEASUREMENTS IN ADVERTISING PRICING

(75) Inventors: Michael Schwarz, Berkeley, CA (US); R. Preston McAfee, San Marino, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, NY (US)

(21) Appl. No.: 12/202,237

(22) Filed: Aug. 30, 2008

(51) Int. Cl. G06Q 30/00

(52) U.S. Cl. 705/400

(57) ABSTRACT

Embodiments of the present invention provides for methods, systems and computer program products for utilizing time measurement in advertising pricing. The method according to one embodiment of the present invention comprises identifying one or more advertisements that are to be displayed in conjunction with one or more web documents. The one or more web documents are displayed in conjunction with the one or more advertisements and a time period the one or more advertisements are displayed is monitored. A monetary value for display of the one or more advertisements is determined on the basis of the time period the one or more advertisements are displayed.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to advertisement pricing. More specifically, the present invention provides systems, methods and computer program products for utilizing time measurement in advertisement pricing.

### BACKGROUND OF THE INVENTION

The World Wide Web provides access to an extraordinary large collection of information sources (in various formats including text, images, videos and other media content) relating to virtually every subject imaginable. Advertising has become the economic foundation of the World Wide Web, with nearly all non-transactional websites relying on revenue generated by the placement of advertisements on their website as a primary source of income. Online advertisements, such as contextual advertisements, are usually associated with network location identifiers, such as URLs, where advertisers have a pre-existing agreement with a website operator or search engine provider to display the online advertisements in association with one or more selected webpages.

In order for advertisers to purchase on-line advertising and web site operators to collect such, revenue, tools have been developed to measure the effectiveness of the placement of on-line advertisements in order to determine advertisement pricing. Examples of conventional pricing models which determine advertisement pricing based upon the effectiveness of the advertisements are: (1) Cost-Per-Click, where an advertiser pays every time a user “clicks” on its advertisement, (2) Cost-Per-Impression, where an advertiser pays for the number of exposures of an advertisement and (3) Cost-Per-Action, where an advertisers pay only if the advertisement results in a completed transaction, such as a sale of an item.

Pay-per-impression and other forms of advertisement pricing fail to fully take into account the amount of attention that a user devotes to viewing an advertisement. Indeed, even if a user does not click on an advertisement, the amount of time that a user is impressed with an advertisement generates some amount of value for an advertiser. For example, a user who devotes some attention to an advertisement may be more likely to execute a transaction with an advertiser at some point in the future. Accordingly, it would be beneficial to advertisers to measure and price the amount of attention that users devote to an advertisement.

Therefore, a need exists for improved systems, methods and computer program products that establish on-line advertisement pricing that accounts for measurements of the attentiveness of an end user viewing the advertisement.

### SUMMARY OF THE INVENTION

Generally, embodiments of the present invention provides for methods, systems and computer program products for utilizing one or more time measurements in advertisement pricing. One embodiment of the present invention is directed towards a method that comprises identifying one or more web documents and identifying one or more advertisement that are to be displayed with the one or more web documents.

The one or more web documents may be displayed with the one or more advertisements. The time period the one or more advertisements are displayed may be monitored and a monetary value for the display of the one or more advertisements determined on the basis of the time period of display of the one or more advertisements. In providing for the utilization of one or more time measurements in advertisement pricing, embodiments of the present invention provide solutions to the need establishing on-line advertisement pricing that accounts for measurements of the attentiveness of an end user viewing the advertisement.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system for utilizing time measurement in advertisement pricing according to one embodiment of the present invention;

FIG. 2 illustrates a flow diagram presenting a method for utilizing time measurement in advertisement pricing according to one embodiment of the present invention;

FIG. 3 illustrates a flow diagram presenting a method for utilizing time measurement in advertisement pricing according to one embodiment of the present invention;

FIG. 4 illustrates a flow diagram presenting a method for utilizing time measurement in advertisement pricing according to another embodiment of the present invention;

FIG. 5 illustrates a flow diagram presenting a method for utilizing time measurement in advertisement pricing according to another embodiment of the present invention; and

FIG. 6 presents one embodiment of a method for utilizing time measurement in advertisement pricing for the display of an advertisement on a web page of a publisher.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

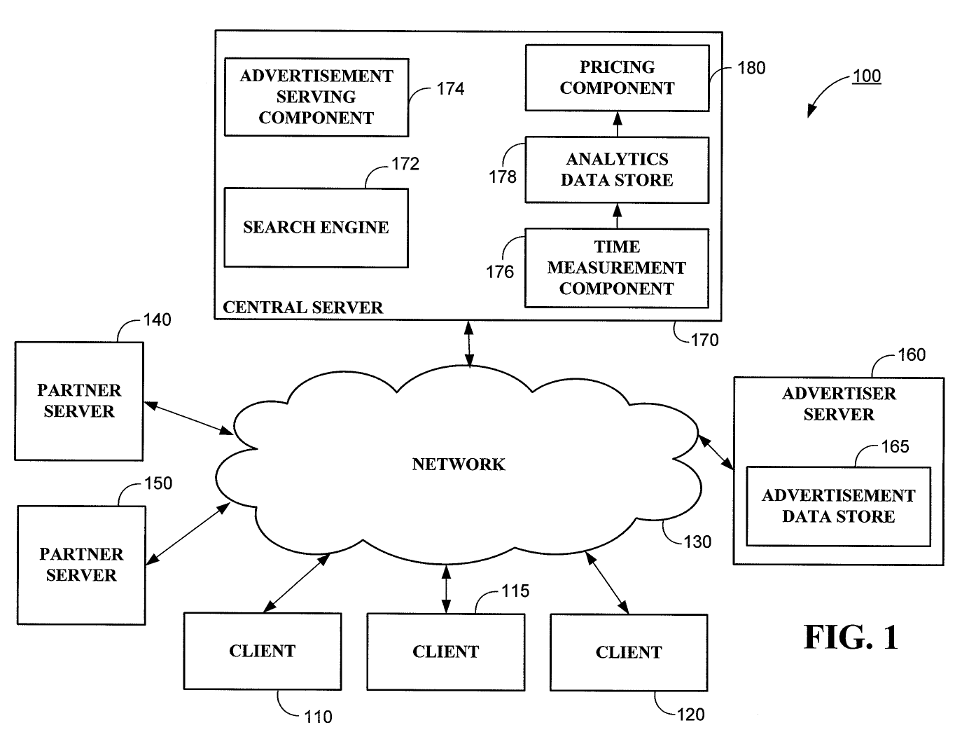

FIG. 1 illustrates one embodiment of a system 100 for utilizing one or more time measurements in advertisement pricing that includes a first client 110, a second client 115 and a third client 120, a computer network 130, a first partner server 140, a second partner server 150, an advertiser server 160 and a central server 170. In the present embodiment, the advertiser server 160 comprises an advertisement data store 165. The central server 170 may comprise a search engine 172, an advertising serving component 174, a time measurement component 176, an analytics data store 178 and a pricing component 180. The advertiser server may comprise an advertisement data store 165.

The computer network 130 may be any type of computerized network capable of transferring data, such as the Internet. According to one embodiment of the invention, the first client device 110, the second client device 115 and the third client device 120 are general purpose personal computers comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc. The present invention is not limited to only the client devices 110, 115 and 120 and may comprise additional, disparate client devices. The client devices 110, 115 and 120 are therefore presented for illustrative purposes representative of multiple client devices.

According to one embodiment of the invention, the first partner server 140, the second partner server 150, the advertiser server 160 and the central server 170 are programmable processor-based computer devices that include persistent and transient memory, as well as one or more network connection ports and associated hardware for transmitting and receiving data on the network 130. The partner servers 140 and 150, the advertiser server 160 and the central server 170 may host websites, store data, serve ads, etc. Those of skill in the art understand that any number and type of client devices 110, 115 and 120, partner servers 140 and 150, advertiser server 160 and central server 170 may be connected to the network 130.

The search engine 172, the advertising serving component 174, the time measurement component 176 and the pricing component 180 may comprise one or more processing elements operative to perform processing operations in response to executable instructions, collectively as a single element or as various processing modules, which may be physically or logically disparate elements. The advertisement data store 165 and the analytics data store 178 may be one or more data storage devices of any suitable type, operative to store corresponding data therein. Those of skill in the art recognize that the central server 170 may utilize more or fewer components and data stores, which may be local or remote with regard to another given component or data store.

In accordance with one embodiment, client devices 110, 115 and 120, the partner servers 140 and 150, the advertiser server 160 and the central server 170 are communicatively coupled to the computer network 130. The client devices 110, 115 and 120 may communicate across the network 130 with the central server 170, which may be maintained and operated by a search provider, by transmitting one or more search queries or one or more URL requests. The search engine 172 of the central server 170 receives the search query and may generate a search request to locate one or more responsive web documents, which may be communicated across the network 130 to the partner servers 140 and 150. The first partner server 140 and the second partner server 150 may contain one or more web documents that are responsive to the search request that the search engine 172 generates, such as news website, an online shopping website, an auction website, a blog website, etc. The search engine 172 may then communicate the location of the one or more web documents that are responsive to the search request to the given requesting client device 110, 115 or 120 via the network 130.

The first partner server 140 and the second partner server 150 may contain data indicating a location to which requests are to be delivered for one or more advertisements to be displayed at the responsive web documents located at the partner servers 140 and 150. For example, a given website located at the first partner server 140 or the second partner server 150 may contain HTML tags or JavaScript code identifying a location to which requests are to be delivered for one or more advertisements to be displayed at the first partner server 140 or the second partner server 150. When a given website on the first partner server 140 or the second partner server 150 is visited by a user of a client device 110, 115 or 120, which may be as a result of the search request generated by the central server 170, a request may be delivered from the client device 110, 115 or 120 to the location specified by the HTML tags, JavaScript code, etc.

According to one embodiment of the invention, a request for one or more advertisements to be displayed at a given website of the first partner server 140 or the second partner server 150 is delivered to the advertisement serving component 174 at the central server 170. The advertisement serving component 174 is operative to search the advertisement data store 165 of the advertisement server 160 to identify and select one or more advertisements for display at a given website of the first partner server 140 or the second partner server 150. For example, the advertisement serving component 174 may select one or more advertisements from the advertisement data store 165 on the basis of the content of the selected website of the first partner server 140 or the second partner server 150 at which the one or more advertisements are to be displayed, as indicated by the request received from the first partner server 140 or the second partner server 150.

The one or more advertisements that are selected are then transmitted for display by the advertising serving component 174 at the selected website of the first partner server 140 or the second partner server 150 on the client device 110, 115 or 120. According to one embodiment, the time measurement component 176 of the central server 170 monitors the amount time a user of the client device 110, 115 or 120 views the one or more advertisements on the selected website. For example, time measurement component 176 may monitor that a user of the client device 110 viewed a dynamic HTML advertisement on a webpage for 23 seconds. Exemplary methods for monitoring the amount of time a viewer views an advertisement is described in commonly owned U.S. patent application Ser. No. 12/039,564, entitled “MEASUREMENT OF THE EFFECTIVENESS OF ADVERTISEMENT DISPLAY ON WEB PAGES,” filed on Feb. 28, 2008 and assigned attorney docket number 8236.003, the disclosure of which is hereby incorporated by reference in its entirety.

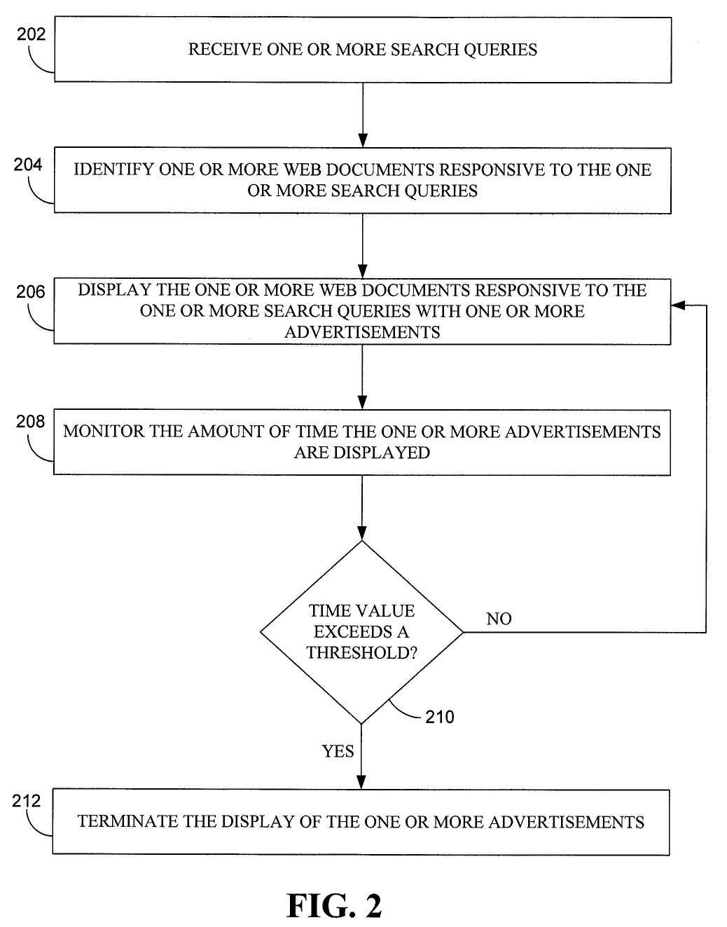

Information associated with the selected website of the first partner server 140 or the second partner server 150 from which advertisements are displayed may be delivered to the analytics data store 178 at the central server 170. Such information may comprise, but not limited to, the frequency with which advertisements are selected at a given website of the first partner server 140 or the second partner server 150, and the frequency with which a conversion results from selection of advertisements displayed at a given website of the first partner server 140 or the second partner server 150. More importantly, for purposes of the present invention, such information may include metrics related to the measurement of time a user of the client device 110, 115, and 120 views the one ore more advertisements displayed on a given website, which according to one embodiment is determined by the time measurement component 176. The information may be passed to the pricing component 180 of the central server 170, which utilizes the information to generate a price value for advertisements on the basis of the time the given website displays the advertisement. Methods for utilizing time measurement in advertisement pricing are described in greater detail below with respect to the description of FIGS. 2 through 5.

FIG. 2 illustrates a flow diagram presenting a method for utilizing one or more time measurements in advertisement display according to one embodiment of the present invention. In accordance with the embodiment of FIG. 2, the method may begin receiving one or more search queries, step 202, and identifying one or more web documents responsive to the one or more search queries, step 204. For example, a search provider may receive the search query “New York Yankees” and return a result set of web documents responsive to the search query “New York Yankees”, using techniques that are known in the art. Continuing with this example, a result set may comprise the homepage of the New York Yankees, as well as webpages maintained and operated by entities that provide sports news, such as Sports Illustrated (http://sportsillustrated.cnn.com/baseball/mlb/teams/yankees/) or ESPN (http://sports.espn.go.com/mlb/clubhouse?team=nyy).

It should be noted by those of skill in the art that embodiments of the present invention, while described in conjunction with search advertising, are equally applicable to display advertisements, such as advertisements placed on a page of a content provider by an advertiser on the basis of the content of the page. For example, where a content provider serves a page regarding the New York Yankees, it is desirable to have advertisements that are targeted to the content of the page. Accordingly, the content of the page, as opposed to keywords in a search query, may form the basis of the selection of advertisements for placement on the page.

The one or more web documents responsive to the one or more search queries may be displayed to the user in conjunction with one or more advertisements, step 206. Continuing from the previous example, the New York Yankees homepage, located at the URL http://newyork.yankees.mlb.com/ may be displayed to a user who submitted the search query in conjunction with an integrated advertisement, such as for example, SONY™ HD televisions. The amount of time the one or more advertisements are displayed may then be monitored, step 208.

A check is made to determine as to whether the amount of time in which the one or more advertisements are displayed exceeds a threshold value, step 210. If the amount of time exceeds the threshold value, the display of the one or more advisements may be terminated, step 212. Continuing from the previous example, the search provider may monitor the amount of time the integrated advertisement for SONY™ HD televisions is displayed on the New York Yankees homepage and, upon determining that the advertisement has been displayed for 30 seconds, may terminate the display of the advertisement. In the event that the amount of time does not exceed the threshold value, flow will return to step 206, continuing with the display of the one or more web documents. Subsequent to the termination of the method of FIG. 2 at step 212, a price may be determined for the display of the advertisement.

It should be noted by those of skill in the art that embodiments of the invention directed towards utilizing one or more time measurements in advertisement pricing may be utilized in conjunction with other pricing methodologies, such as taking into account time on a given page as part of an overall pricing strategy that also incorporates pay-per-click, pay-per-acquisition, etc., which may be negotiated or determined by auction. For example, an advertiser may submit a bid-per-click and a bid-per-second, whereby advertisements may be arranged to maximize overall revenue and the payment to a given advertiser may be computed using auction mechanisms well known to those of skill in the art.

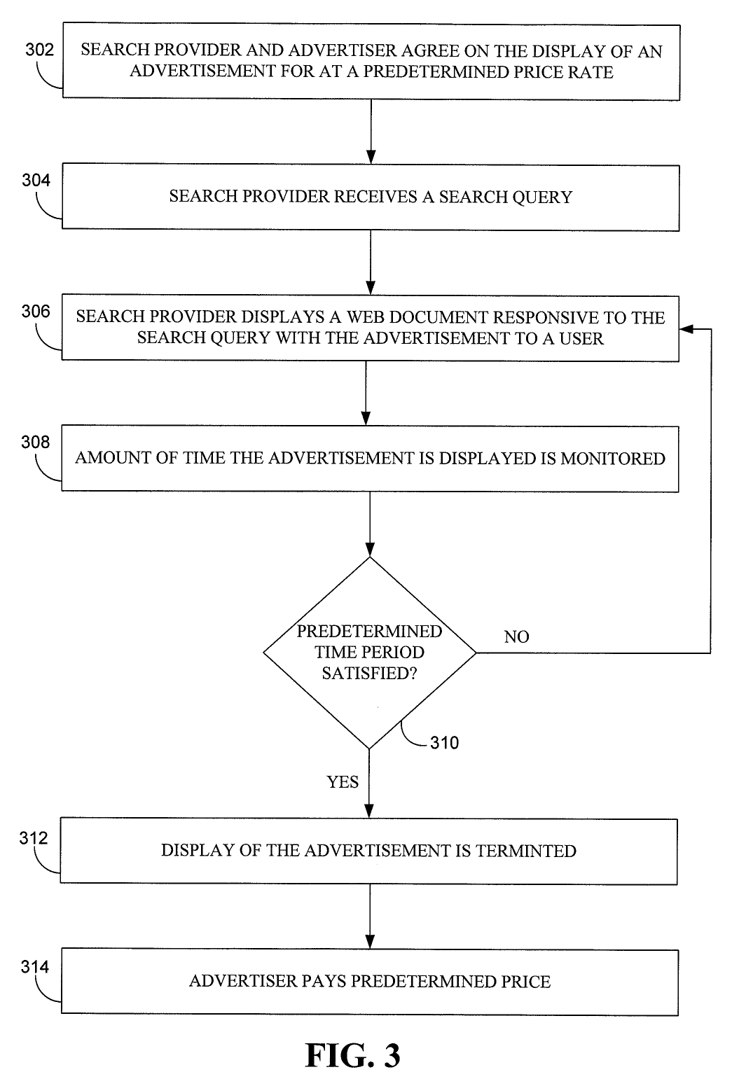

FIG. 3 presents a flow diagram illustrating a method for utilizing one or more time measurements in advertisement pricing according to one embodiment of the present invention. In accordance with the embodiment of FIG. 3, the method may begin by the search provider and advertiser agreeing on the display of an advertisement for a predetermined time period in return for a predetermined price, step 302. For example, an automobile advertiser and a search provider may agree that the advertiser's advertisement is to be displayed on a search result page for search queries relating to automobiles or on specific web documents responsive to the search query, for a time period of twenty seconds, and that the advertiser is to pay two cents per second.

The search provider may receive a search query from a user, step 304, in response to which the search provider displays to a user a web document responsive to the search query with an advertisement integrated or displayed in conjunction with the web document, step 306. Continuing from the previous example, a user may submit the search query “sports car” and the search provider may return an automobile review for a certain sports car responsive to the search query with an integrated contextual advertisement of the automobile advertiser.

The amount of time the advertisement is displayed may be monitored, step 308. For example, a time measurement component, such as the time measurement component 176 of system 100, may monitor that the time period in which the automobile advertisement was displayed was twenty seconds. A determination may be made as to whether the advertisement has been displayed for the predetermined time period agreed upon by the advertiser and the search provider, step 310. If the predetermined time period for the display of the advertisement has not been satisfied, program flow returns to step 306. Continuing from the previous example, if it is determined that the advertisement was displayed for a period of less than twenty seconds, the advertisement will be continued to be displayed.

If the predetermined time period for the display of the advertisement has been satisfied, the display of the advertisement may be terminated, step 312. For example, a determination may be made that the advertisement was displayed for the twenty second time period upon which the automobile advertiser and the search provider agreed to display the advertisement at rate of two cents per second. Accordingly, the automobile advertiser pay the predetermined price for the display of its advertisement, step 314. According to another embodiment, the advertiser and search provider may agree solely on a predetermined price rate per second, where continuing from the previous example, if the advertisement is displayed for less than twenty seconds, the advertiser pays only for the time period during which the advertisement was displayed.

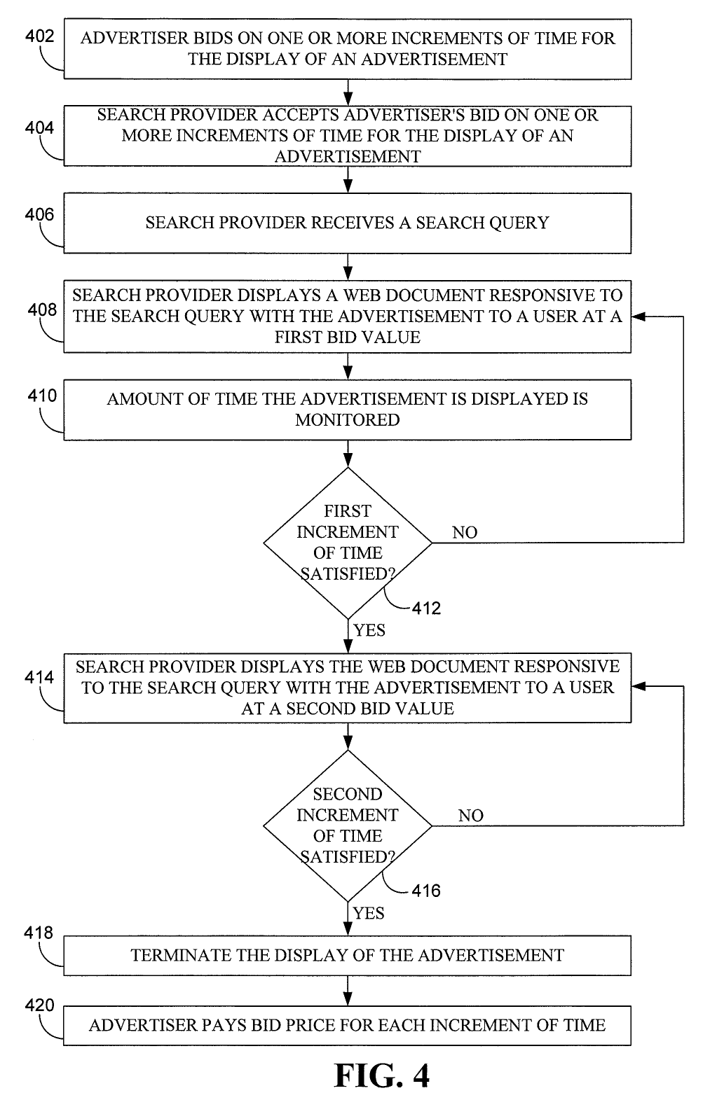

FIG. 4 illustrates a flow diagram presenting a method for utilizing one or more time measurements in advertisement pricing according to another embodiment of the present invention. In accordance with the embodiment of FIG. 4, the method may begin by an advertiser bidding on or more increments of time for the display of an advertisement to a user, step 402. Continuing from the previous example, the automobile advertiser may bid on increments of time for the display of its advertisement, such as five cents per second for the first ten seconds of the display of the advertisement and three cents per second for the next twenty seconds of the display of the advertisement. According to one embodiment, the rationale for a bidding scheme where increments of time would be priced at different monetary rates may be that the display of an advertisement during the first ten seconds are more valuable to an advertiser as an end user using a client device to view a website with the advertisement may be more attentive to the advertisement in the first ten seconds than compared to the next twenty second time period. The search provider may accept the advertiser's bid on the one or more increments of time for the display of the advertisement, step 404.

The search provider may receive a search query from a user, step 406, in response to which the search provider displays a web document responsive to the search query with the advertisement to a user at a first bid value, step 408. The amount of time the advertisement is displayed may be then monitored, step 410. A determination may be then made as to whether the advertisement has been displayed for the time period established by a first increment of time upon which the advertiser has bid upon, step 412.

Continuing from the previous example, a determination is made as to whether the advertisement has been displayed for the ten second increment of time that the automobile advertiser bid upon at the five cents per second rate. If the determination is made that the advertisement has not been displayed for the first increment of time bid upon by the advertiser, program flow returns to step 408. If the first increment of time has lapsed, the search provider may display the web document responsive to the search query with the advertisement to a user at a second bid value, step 414. Continuing from the previous example, the advertisement would be displayed at monetary rate of three cents per second.

A determination may be then made as to whether the advertisement has been displayed for the time period established by a second increment of time upon which the advertiser has bid upon, step 412. If the second increment of time has not lapsed, program flow returns to step 414. If the determination is made that the advertisement has been displayed for the second increment of time bid upon by the advertiser, the display of the advertisement may be terminated, step 418. Accordingly, the advertiser pay the bid price for each increment of time for the display of its advertisement, step 420. From the previous example, the advertiser pay fifty cents for the first ten second time increment and sixty cents for the next twenty second time period.

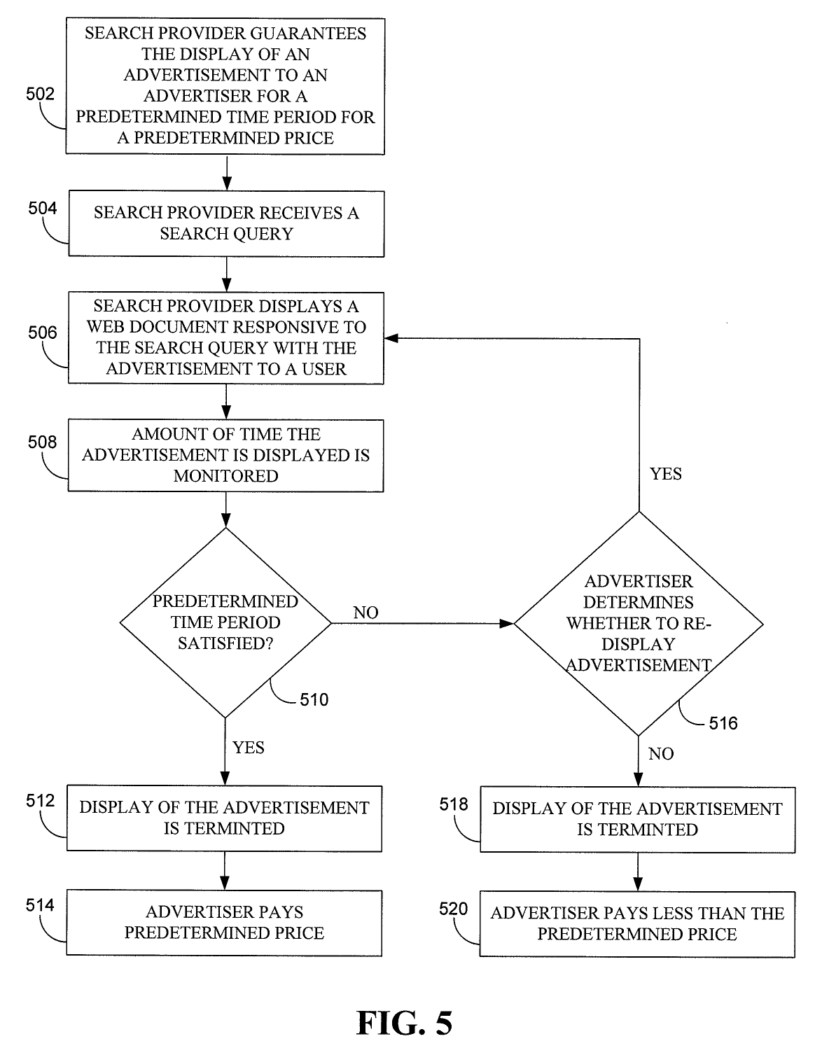

FIG. 5 illustrates a flow diagram presenting a method for utilizing one or more time measurements in advertisement pricing according to another embodiment of the present invention. In accordance with the embodiment of FIG. 5, the method may begin by a search provider guaranteeing to an advertiser the display of an advertisement for a predetermined time period for a predetermined price, step 502. For example, the search provider from the previous examples may guarantee to the automobile advertiser that the advertisement will be displayed for period of thirty seconds at a rate of four cents per second. The search provider may receive a search query from a user, step 504, and may display a web document responsive to the search query to a user in conjunction with the advertisement, step 506. The amount of time the advertisement is displayed may be monitored, step 508.

According to the present embodiment, a determination is made as to whether the advertisement has been displayed for the predetermined time period guaranteed by the search provider to the advertiser, step 510. If the predetermined time period for the display of the advertisement has been satisfied, the display of the advertisement may be terminated, step 512, with the advertiser paying the predetermined price, step 514. Continuing from the previous example, if the advertisement is displayed for thirty seconds, the search provider has satisfied its guarantee to the advertiser and the advertiser in turn will pay $1.20. If the predetermined time period for the display of the advertisement has not been satisfied, step 510, a determination may be made by the advertiser as to whether to redisplay the advertisement, step 516. For example, if the search provider fails to satisfy its guarantee as to the display of the advertisement, the advertiser has the option of having the advertisement redisplayed in another responsive web document until the advertisement is displayed for the guaranteed time period or, instead, may pay for display of the advertisement at lesser monetary rate per second.

If the advertiser decides to have the advertisement redisplayed, program flow returns to step 506. If the advertiser determines that the advertisement is not to be redisplayed, the display of the advertisement may be terminated, step 518, and the advertiser may pay less than the predetermined price, step 520. Continuing from the previous example, the advertiser may choose the option of paying less than the predetermined price of four cents per second and instead only pay three cents per second as the advertisement was not displayed for the guaranteed time period. Alternatively, the advertiser may pay the predetermined price per second, but only for the amount of time that the user was viewing the advertisement.

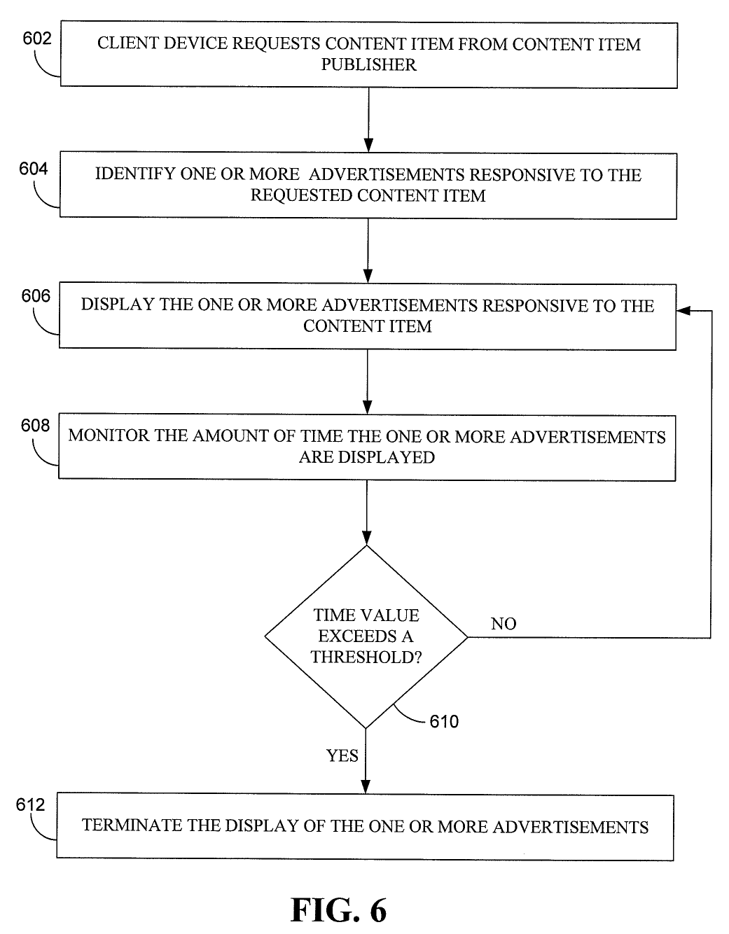

As indicated above, embodiments of the present invention are applicable to display advertising, in addition to the search-based presentation of advertisements (displayed in conjunction with a search results page). FIG. 6 presents one embodiment of a method for utilizing time measurement in advertisement pricing for the display of an advertisement on a web page of a publisher. The method according to the embodiment of FIG. 6 begins with the request for a web page or other content item from a client device under the operation of an end user, step 602, and one or more advertisements are identified that are responsive to the requested content item, step 604. For example, identification of advertisements may be made on the basis of a context of the requested content item or the content of the content item, such as one or more keywords are appear in or are associated with the content item. According to the present embodiment, a client device receives and renders the content item and one or more advertisements for display at the client device, step 606.

The method may then monitor an amount of time the one or more advertisements are displayed may then be monitored, step 608. According to one embodiment, program code in the content item is run by the client device to determine the amount of time the one or more advertisements are displayed. Alternatively, or in conjunction with the foregoing, the client device may in communication with a central server to transmit the amount of time the one or more advertisements are displayed.

A check is made to determine as to whether the amount of time in which the one or more advertisements are displayed exceeds a threshold value, step 610. If the amount of time exceeds the threshold value, the display of the one or more advisements may be terminated, step 612. In the event that the amount of time does not exceed the threshold value, program flow returns to step 606, continuing with the display of the one or more advertisements. Subsequent to the termination of the method of FIG. 6 at step 212, a price may be determined for the display of the advertisement, which may be for display of the advertisement over the time period.

In accordance with the foregoing description, the present invention provides systems, methods and computer program products for utilizing one or more time measurements in advertisement pricing. In providing for the utilization of one or more time measurements in advertisement pricing, embodiments of the present invention provide a solution to the need for on-line advertisement pricing that accounts for measurements of the attentiveness of an end user viewing the advertisement. It should be understood that the embodiments set forth in the present description are not inclusive of all of the possible embodiments that could incorporate the present invention and therefore are not meant to limit the scope of the present invention, as one or more time measurements may be incorporated as a basis for multiple pricing schemes involving on-line advertising.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for determining advertisement pricing, the method comprising:
identifying one or more advertisements that are to be displayed in conjunction with the one or more web documents;
displaying the one or more web documents responsive in conjunction with the one or more advertisements;
monitoring a time period over which the one or more advertisements are displayed; and
determining a monetary value for display of the one or more advertisements on the basis of the time period.

2. The method of claim 1, comprising predetermining a monetary rate value per time increment for display of the one or more advertisements.

3. The method of claim 1, comprising predetermining one or more time periods for the display of the one or more advertisements.

4. The method of claim 3, comprising displaying the one or more advertisements for the one or more time periods.

5. The method of claim 1, comprising bidding a monetary rate value per time increment for display of the one or more advertisements for one or more predetermined time periods.

6. The method of claim 1, comprising guaranteeing display of one or more advertisements for one or more predetermined time periods.

7. The method of claim 6, comprising predetermining a monetary rate value per time increment for display of the one or more advertisements for the guaranteed one or more predetermined time periods.

8. The method of claim 7, comprising determining a monetary rate value per time increment for display of the one or more advertisements when the time period for display of the one or more advertisements is less than the guaranteed one or more predetermined time periods.

9. Computer readable media comprising program code that when executed by a programmable causes execution of a method for determining advertisement pricing, the computer readable media comprising:
program code for identifying one or more advertisements that are to be displayed in conjunction with one or more web documents;
program code for displaying the one or more web documents responsive to the one or more search queries in conjunction with the one or more advertisements;
program code for monitoring a time period the one or more advertisements are displayed; and
program code for determining a monetary value for display of the one or more advertisements on the basis of the time period the one or more advertisements are displayed.

10. The computer readable media of claim 9, comprising program code for predetermining a monetary rate value per time increment for display of the one or more advertisements.

11. The computer readable media of claim 9, comprising program code for predetermining one or more time periods for display of the one or more advertisements.

12. The computer readable media of claim 11, comprising program code for displaying the one or more advertisements for the one or more time periods.

13. The computer readable media of claim 9, comprising program code for bidding a monetary rate value per time increment for display of the one or more advertisements for one or more time periods.

14. The computer readable media of claim 9, comprising program code for guaranteeing display of one or more advertisements for one or more predetermined time periods.

15. The computer readable media of claim 14, comprising program code for predetermining a monetary rate value per time increment for display of the one or more advertisements for the guaranteed one or more predetermined time periods.

16. The computer readable media of claim 15, comprising program code for determining a monetary rate value per time increment for display of the one or more advertisements when the time period for display of the one or more advertisements is less than the guaranteed one or more predetermined time periods.

17. A system for determining advertisement pricing, the system comprising:
a computer network;
a search engine operative to,
receive one or more search queries;
identify one or more web documents responsive to the one or more search queries;
an advertisement serving component operative to identify one or more advertisements for display in conjunction with the one or more web documents responsive to the one or more search queries;
a client device operative display the one or more web documents responsive to the one or more search queries in conjunction with the one or more advertisements;
a time measurement component operative to monitor a time period over which the one or more advertisements are displayed; and
a pricing component operative to determine a monetary value for display of the one or more advertisements on the basis of the time period the one or more advertisements are displayed.

18. The system of claim 17, wherein the pricing component is operative to predetermine a monetary rate value per time increment for display of the one or more advertisements.

19. The system of claim 17, wherein the pricing component is operative to predetermine one or more time periods for display of the one or more advertisements.

20. The system of claim 19, wherein the client device is operative to display the one or more advertisements for the one or more predetermined time periods.

21. The system of claim 17, wherein the pricing component is operative to receive one or more bids for a monetary rate value per time increment for display of the one or more advertisements for one or more predetermined time periods.

22. The system of claim 17, wherein the pricing component is operative to guarantee display of one or more advertisements for one or more predetermined time periods.

23. The system of claim 22, wherein the pricing component is operative to predetermine a monetary rate value per time increment for display of the one or more advertisements for the guaranteed one or more predetermined time periods.

24. The system of claim 23, wherein the pricing component is operative to determine monetary rate value per time increment for display of the one or more advertisements when the time period for display of the one or more advertisements is less than the guaranteed one or more predetermined time periods.
